(19) United States
(12) Patent Application Publication
(10) Pub. No.: US 2005/0129837 A1
(43) Pub. Date: Jun. 16, 2005

(54) Creation method of dyed drawing of plant matter

(76) Inventor: Nobuo Sugino, Yokohama (JP)

Correspondence Address: JORDAN AND HAMBURG LLP, 122 EAST 42ND STREET, SUITE 4000, NEW YORK, NY, 10168, US

(21) Appl. No.: 10/736,186

(22) Filed: Dec. 15, 2003

(51) Int. Cl. A01N 1/00

(52) U.S. Cl. 427/4

(57) ABSTRACT

The creation method of a dyed drawing includes a step of arranging of the mesh sheet at the surface of the canvas for the dyed drawing, arranging the leaves and flowers on the upper surface of the mesh sheet, covering on the plant matter with the synthetic resin sheet, painting the dyed drawing at a canvas including pushing the leaf and flower to the mesh sheet after pressing the synthetic resin sheet by the spatula etc., flowing a pigment of the leaf and flower out and adhering the pigment to the canvas, and removing the mesh sheet, the leaf and flower and the synthetic resin sheet which are located on the surface of the canvas for the dyed drawing so that it can create the dyed drawing, adhering the pigment of leaves and flower of the plant matter to the drawing paper, canvas, etc. in the transfer state, and everyone can do easily, and it can be introduced to the subject of a culture classroom.

### BACKGROUND OF THE INVENTION

This invention relates to a creation method of a dyed drawing of a plant matter, making adhering the pigment of leaves and flower of the plant matter to drawing paper, canvas, etc. in the transfer state.

In the conventional dyed drawing, the leaves and flowers of the plant matter are located on the cloth such as cotton and hemp, and&it is stroked by a hammer. Then, the pigment of the leaves and flowers is adhered to the cloth.

In the conventional dyed drawing, the leaves and flowers of the plant matter are stroked with the hammer, and the pigment of the leaves and flowers is transferred to the cloth such as cotton and hemp. Therefore, it is difficult to transfer as the form of the leaves and flowers, and it is too hard to create a beautiful dyed drawing.

Moreover, it is possible to give the dyed drawing to only the cloth which has unevenness in the surface thereof such as cotton and hemp.

### SUMMARY OF THE INVENTION

Accordingly, it is an object of the invention to provide a creation method of a dyed drawing of a plant matter that can create the dyed drawing, adhering the pigment of leaves and flower of the plant matter to drawing paper, canvas, etc. in the transfer state. It is another object of the invention to provide a creation method of a dyed drawing of a plant matter that everyone can do easily, and it can be introduced to the subject of a culture classroom.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF TIE DRAWINGS

FIG. 1 is a flow diagram showing a first embodiment of the present invention;

FIG. 2 is an examination view of a step for arranging a mesh sheet;

FIG. 3 is an examination view of a step for arranging a plant matter;

FIG. 4 is an examination view of a step for arranging an absorption sheet;

FIG. 5 is an examination view of a step for covering;

FIG. 6 is an examination view of a step for painting a dyed drawing;

FIG. 7 is an examination view of a step for removing;

FIG. 8 is an examination view of a step for fixing a pigment;

FIG. 9 is an examination view showing the way in which the extra pigment is absorbed in the absorption sheet;

FIG. 10 is a flow diagram showing a second embodiment of the present invention;

FIG. 11 is an examination view of a mesh sheet;

FIG. 12 is an examination view of a step for painting a dyed drawing;

FIG. 13 is a flow diagram showing a third embodiment of the present invention;

FIG. 14 is an examination view of a step for painting a dyed drawing;

FIG. 15 is an examination view of a step for coloring;

FIG. 16 is a flow diagram showing a fourth embodiment of the present invention;

FIG. 17 is an examination view of a step for hurting a plant matter;

FIG. 18 is an examination view of a step for arranging a plant matter;

FIG. 19 is a flow diagram showing a fifth embodiment of the present invention;

FIG. 20 is an examination view of a step for enclosing;

FIG. 21 is a front view showing the way in which it is put in a picture frame;

FIG. 22 is a cross sectional view taken along a line 22-22 of FIG. 21;

FIG. 23 is a flow diagram showing a sixth embodiment of the present invention;

FIG. 24 is an examination view of a step for neutralizing an object for dyed drawing;

FIG. 25 is a flow diagram showing a seventh embodiment of the present invention;

FIG. 26 is an examination view of a step for preventing oxidization;

FIG. 27 is a flow diagram showing an eighth embodiment of the present invention;

FIG. 28 is an examination view of a step for arranging a plant matter;

FIG. 29 is an examination view of a step for arranging a fixing sheet;

FIG. 30 is a flow diagram showing a ninth embodiment of the present invention;

FIG. 31 is a perspective view of a canvas for a dyed drawing of a plant matter;

FIG. 32 is an examination view for impregnating with a pH setting solution;

FIG. 33 is an examination view of a step for after-treatment;

FIG. 34 is a flow diagram showing a tenth embodiment of the present invention;

FIG. 35 is a perspective view of a canvas for a dyed drawing of a plant matter;

FIG. 36 is an examination view of a canvas for a dyed drawing of a plant matter;

FIG. 37 is a flow diagram showing an eleventh embodiment of the present invention;

FIG. 38 is a perspective view of a canvas for a dyed drawing of a plant matter;

FIG. 39 is an examination view of a canvas for a dyed drawing of a plant matter;

FIG. 40 is a flow diagram showing a twelfth embodiment of the present invention;

FIG. 41 is an examination view of a step for after-treatment;

FIG. 42 is a flow diagram showing a thirteenth embodiment of the present invention;

FIG. 43 is a perspective view of a canvas for a dyed drawing of a plant matter;

FIG. 44 is an examination view of a step for arranging a plant matter;

FIG. 45 is a flow diagram showing a fourteenth embodiment of the present invention;

FIG. 46 is an examination view of a step for arranging a plant matter;

FIG. 47 is an examination view of a step for arranging an absorption sheet;

FIG. 48 is a flow diagram showing a tenth embodiment of the present invention;

FIG. 49 is a perspective view of a canvas for a dyed drawing of a plant matter; and

FIG. 50 is an examination view showing the way in which a dyed drawing of a plant matter is attached.

### DETAILED DESCRIPTION OF THE PREFERRED EMBODIMENTS

Preferred embodiments of the present invention are described in more detail below with reference to the accompanying drawings.

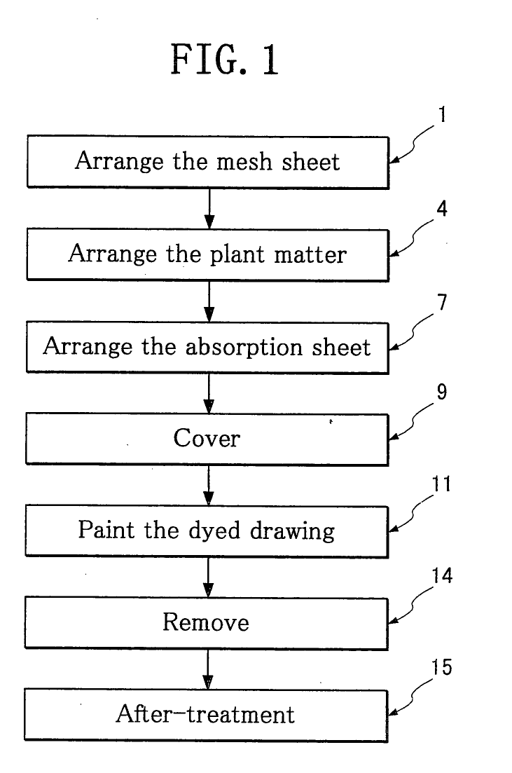

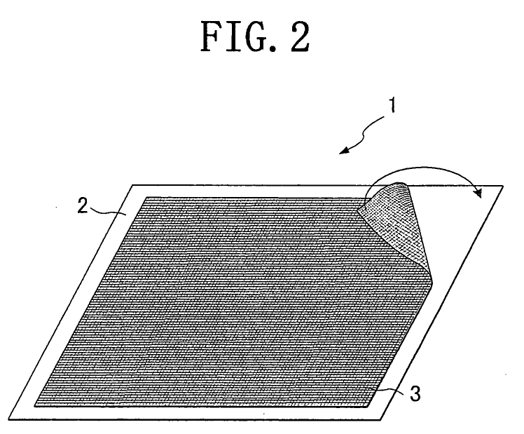

FIGS. 1-9 illustrate a transfer method and an adhesive for transfer in accordance with a first embodiment of the present invention.

The numeral 1 shows a step for arranging a mesh sheet, and the mesh sheet is arranged at a surface part which is drawn the dyed drawing, of a canvas 2 for the dyed drawing, the canvas 2 including a drawing paper, cloth, canvas which can draw the dyed drawing of the plant matter. The canvas 2 for the dyed drawing of the plant used in the arrangement step 1 of the mesh sheet is used as it is if it has a water absorption rate. On the other hand, the canvas 2 is used so as to have a water absorption rate after it is sprayed alcohol, water, acid liquid or these mixtures if it has a low water absorption rate.

Moreover, the mesh sheet 3 is comprised of the meshes having approximately 0.1 millimeters to several millimeters, and the thread of the mesh sheet 3 may be used at any material. If possible, the thread of the synthetic resin material may be used so that it is re-used easily by washing

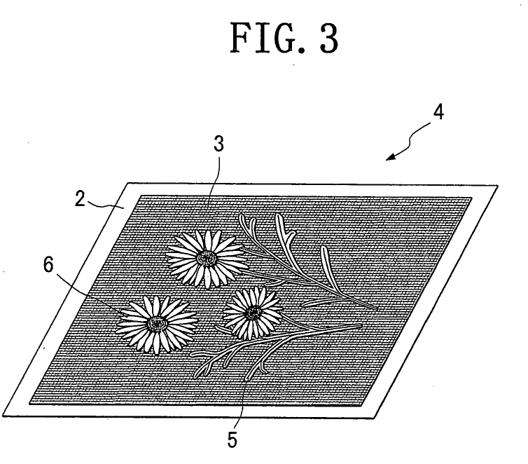

The numeral 4 shows a step for arranging the plant matter, and as shown in FIG. 3, leaves 5 and flowers 6 of the plant matter which are drawn the dyed drawing are arranged on the upper surface of the mesh sheet 3 after the mesh sheet arrangement step 1 is carried out. The leaves 5 and flowers 6 of the plant matter which are arranged on the upper surface of the mesh sheet 3 at this step 4 can make the pigment of the leaf 5 and flower 6 flow out of the leaf and flower efficiently so that the back surface of the leaf 5 and flower 6 is arranged so as to attach to the mesh sheet 3, compared with the arrangement such that the surface of the leaf 5 and flower 6 is attached to the mesh sheet 3.

In addition, although the leaf 5 and flower 6 used for the dyed drawing is used at fresh flowers, the user may use the pressed flower, flowers that the dried flowers are restored in the boiling water, hot water, water, alcohol, etc.

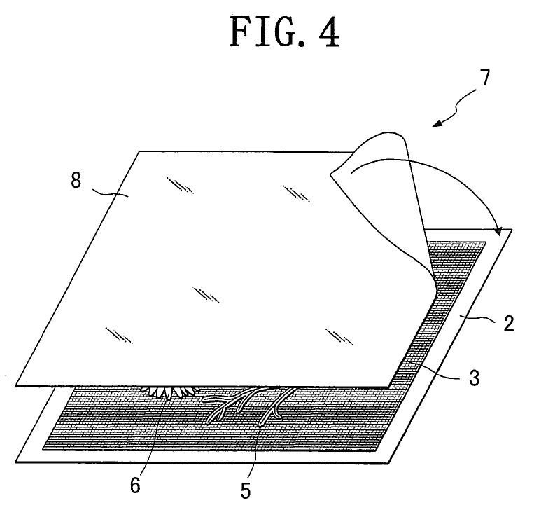

The numeral 7 shows a step for arranging a thin absorption sheet 8, and as shown in FIG. 4, the absorption sheet 8 with water absorption rate covers the upper surface of the plant matter after the arrangement step 4 is carried out. The water absorption sheet 8 used at this step 7 is used at a tissue paper, toilet paper, etc.

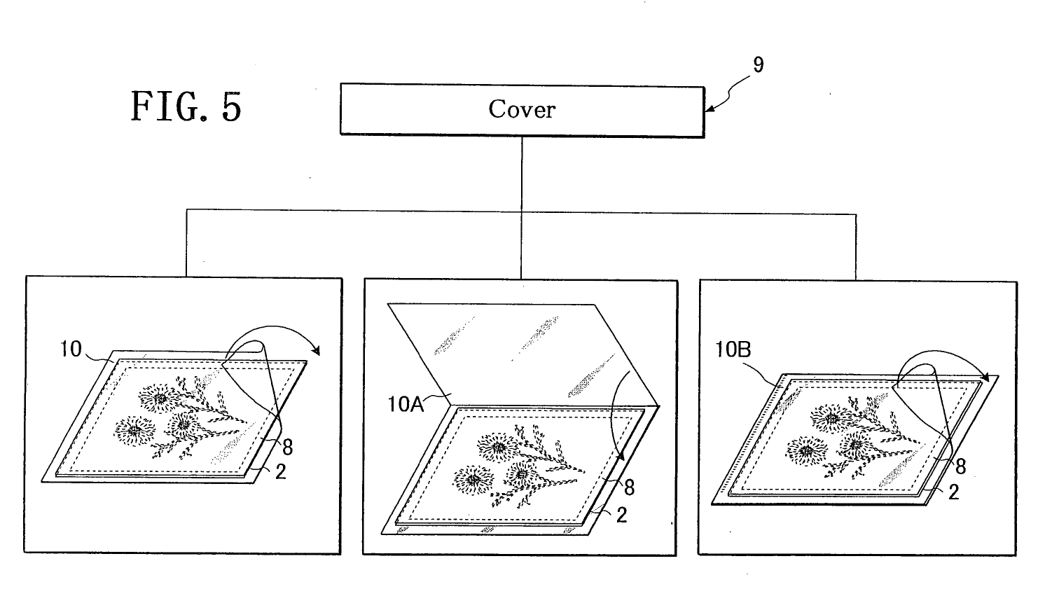

The numeral 9 shows a step for covering, and as shown in FIG. 5, a transparent or translucent synthetic resin sheet 10 covers on the upper surface of the water absorption sheet 8 after the arrangement step 7 is carried out. In the cover step 9, the user may use either the synthetic resin sheet 10 formed in the shape of a sheet, covering on the upper surface of the water absorption sheet 8, the synthetic resin sheet 10A with half fold, a lower part thereof inserting under the canvas 2 for the dyed drawing and an upper part thereof covering on the water absorption sheet 8 or the synthetic resin sheet 10B using the clear file.

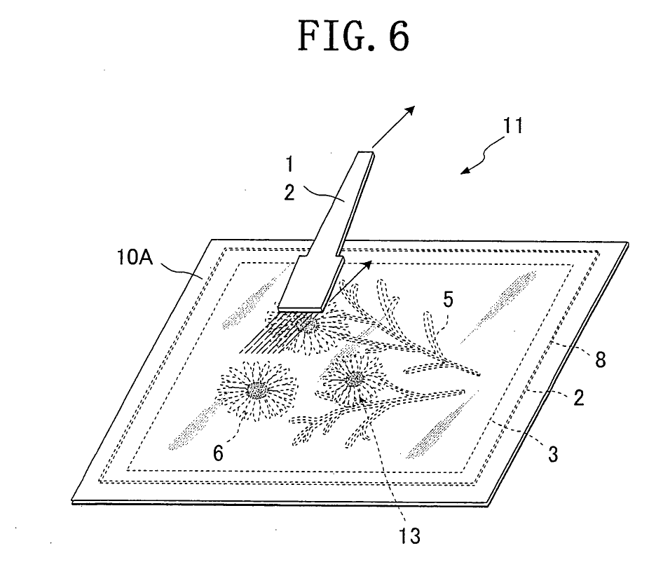

The numeral 11 shows a step for painting the dyed drawing after the covering step 9 is carried out. As shown in FIG. 6, the synthetic resin sheet 10A is pressed by a spatula 12, the leaf 5 and flower 6 of the plant matter is pushed to the mesh sheet 3, and the pigment adheres to the canvas 2 for the dyed drawing after the pigment of the plant flows out. Then, the water absorption sheet 8 absorbs water, and a dyed drawing 13 of the plant matter is drawn on the canvas 2 for the dyed drawing when there is much pigment which flows out of the leaf 5 and flower 6. In the painting step 11, the pigment of the leaf 5 and flower 6 is flown out after the user presses or strikes so as to slide on the resin sheet 10A of the upper part of the leaf 5 and flower 6 by the spatula 12, and the leaf 5 and flower 6 is pushed to the mesh sheet 3 and scratched.

In addition, the spatula 12 is formed in the shape of a rice paddle, and the shape thereof may be formed in any design which can push so as to allow the pigment flow out by pressing the leaf 5 and flower 6 located under the synthetic resin sheet 10A, the design including a roller attached at a tip portion of the spatula, marble, spatula with spherical surface including hemisphere and the like.

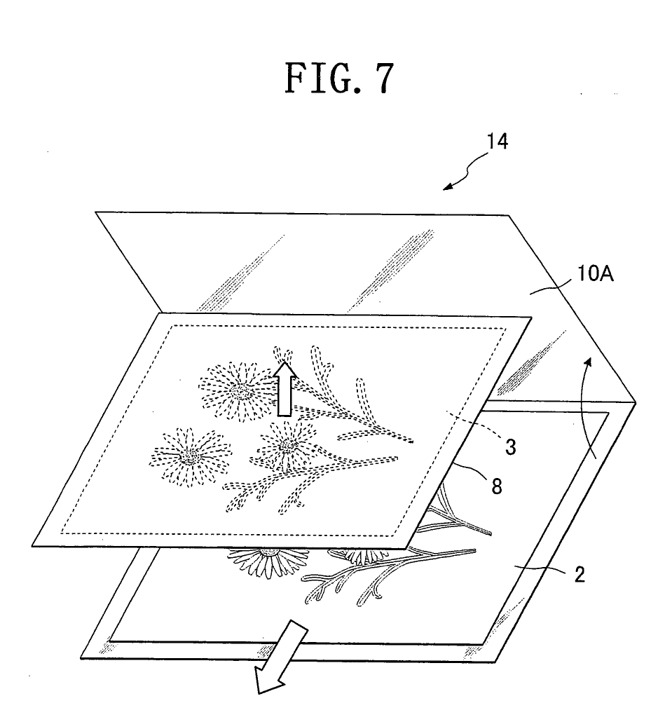

As shown in FIG. 7, the numeral 14 shows a step for removing the mesh sheet 3, the leaf 5 and flower 6 of the plant matter, the water absorption sheet 8 and the synthetic resin sheet 10A which is located on the surface of the canvas 2 for the dyed drawing after the painting step 11 is carried out.

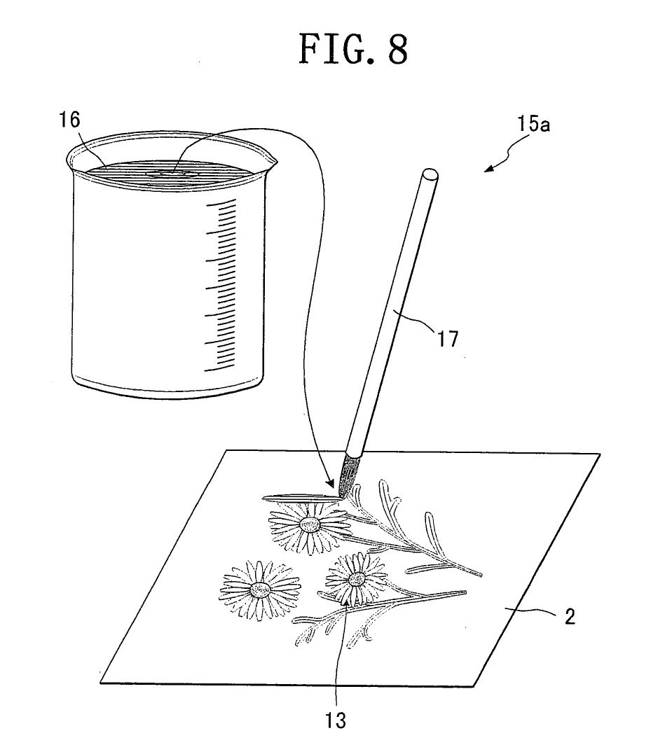

The numeral 15 shows a step for after-treatment if needed after the removal step 14 is carried out. As shown in FIG. 8, in the embodiment of the present invention, the after-treatment step 15 is a step 15a for fixing the pigment of the part of the dyed drawing 13. In the fixing step 15a, a fixing solution 16 of pigment including alum liquid and salt water is applied in the part of the dyed drawing 13 by a brush 17. Moreover, if necessary, the user may perform the coating of resin including silicone and acrylics, or hot-melt resin on the upper surface of the dyed drawing 13.

The dyed drawing 13 of the plant drawn on the canvas 2 for the dyed drawing by the creation method of the dyed drawing creates the picture in the state that the pigment of the outline of the leaf 5and flower 6 is transferred.

Moreover, when the leaf 5 and flower 6 is pushed and pressed to the mesh sheet 3 by the spatula 12, the parts attached the leaf 5 and flower 6 to the mesh sheet 3 is scratched, and the pigment flows out efficiently and adheres to the canvas 2 for the dyed drawing.

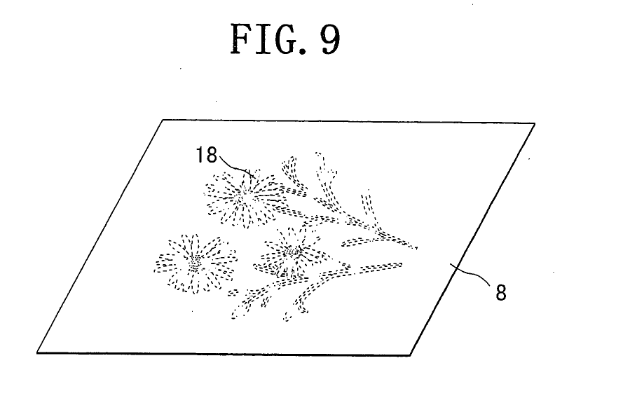

Furthermore, the spatula 12 moves slidely with pressing on the synthetic resin sheet 10A so that the leaf 5 and flower 6 are fixed and not break its outline; the pigment can be adhered to the canvas 2 for the dyed drawing in the state that the outline of the leaf 5 and flower 6 still exist; and the extra pigment 18 is adsorbed by the water absorption sheet 8 as shown in FIG. 9. Because the pigment adheres to the water absorption sheet, the user can check the outline of the leaf 5 and flower 6 and can operate the spatula 12 with adjusting.

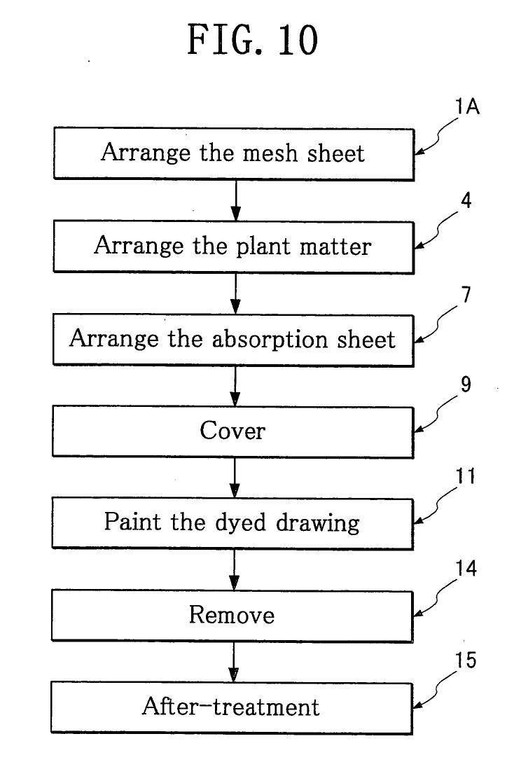

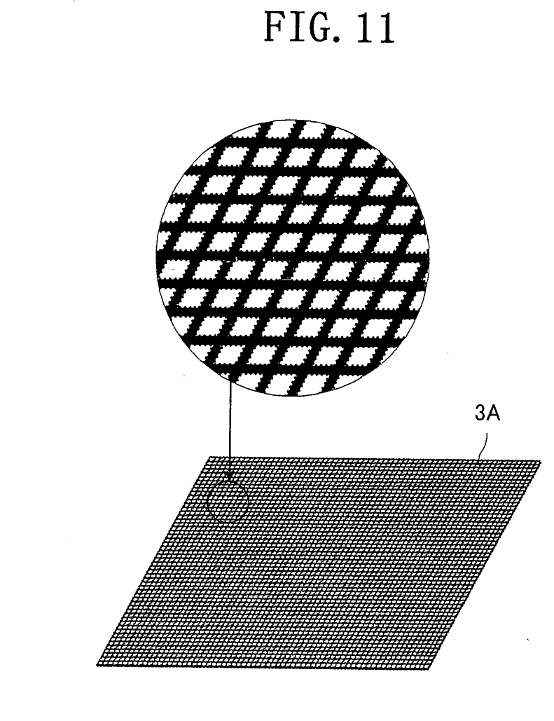

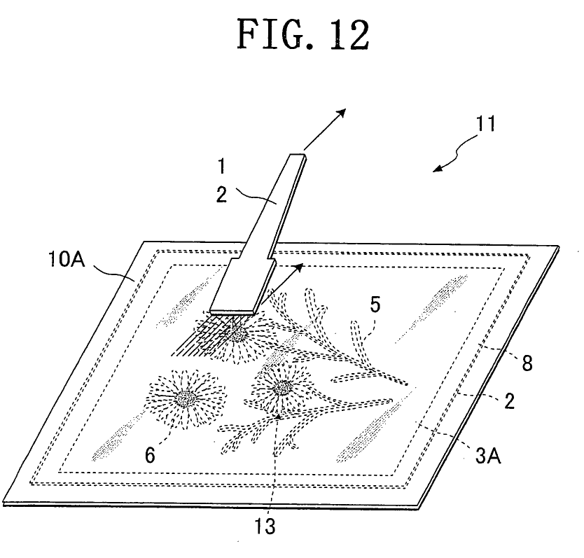

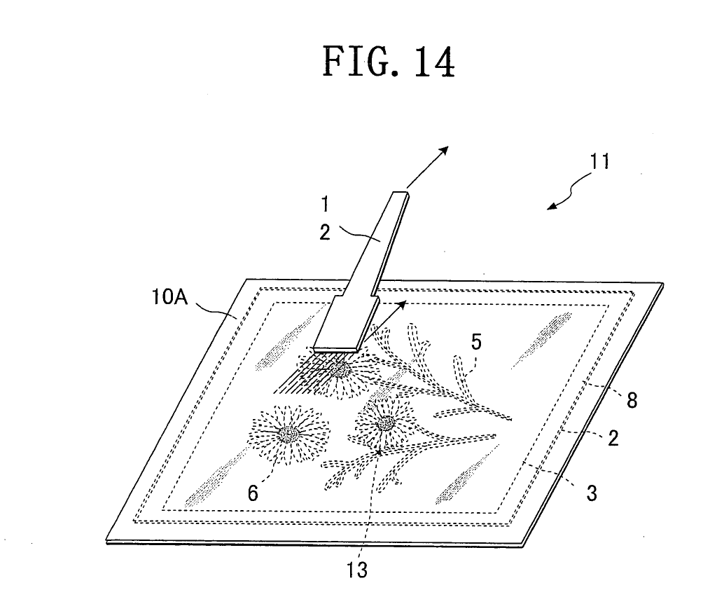

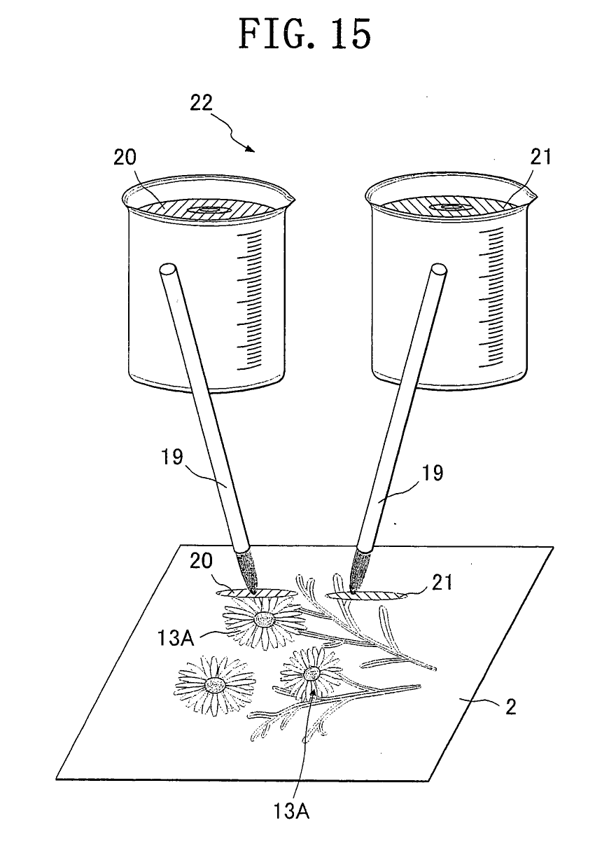

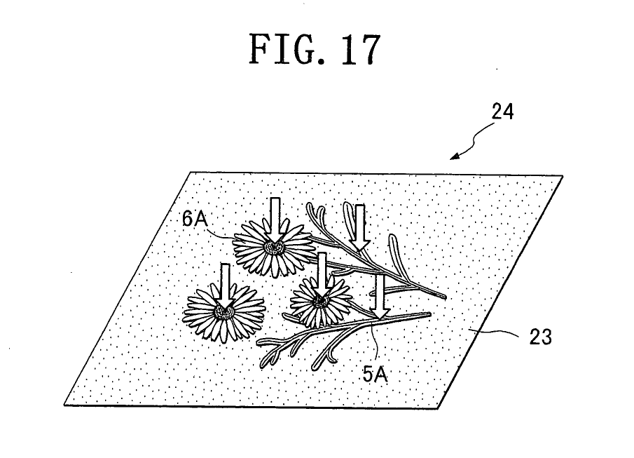

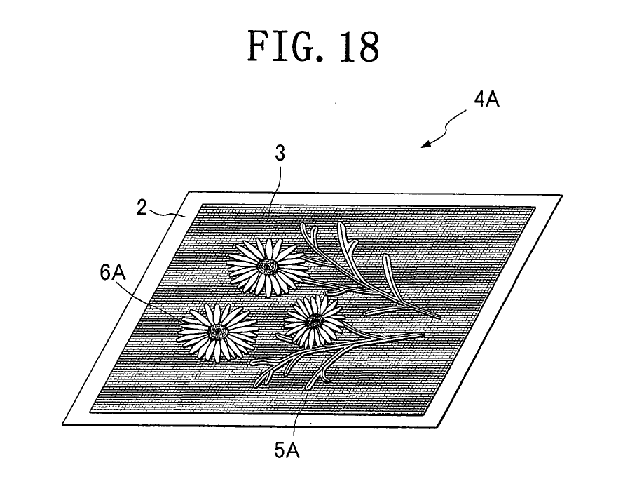

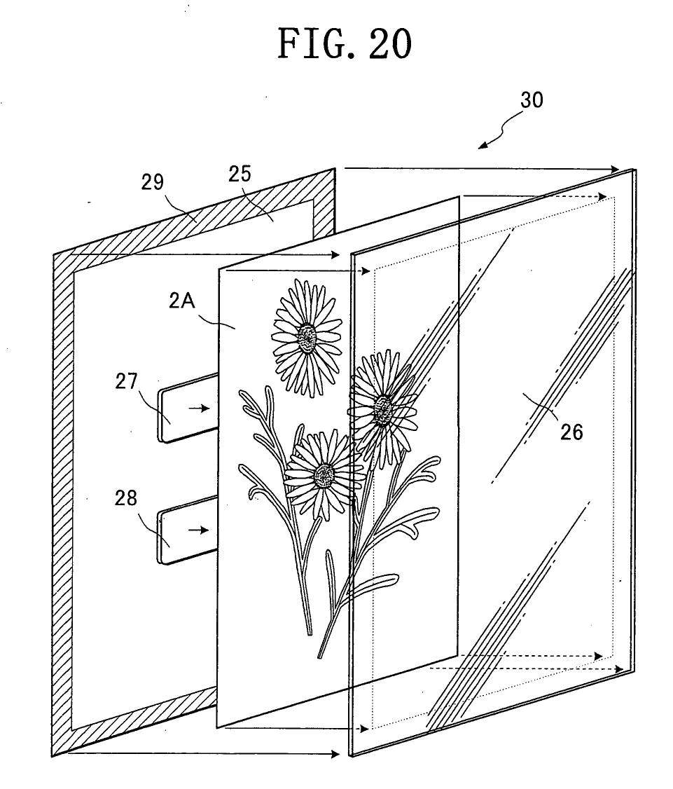

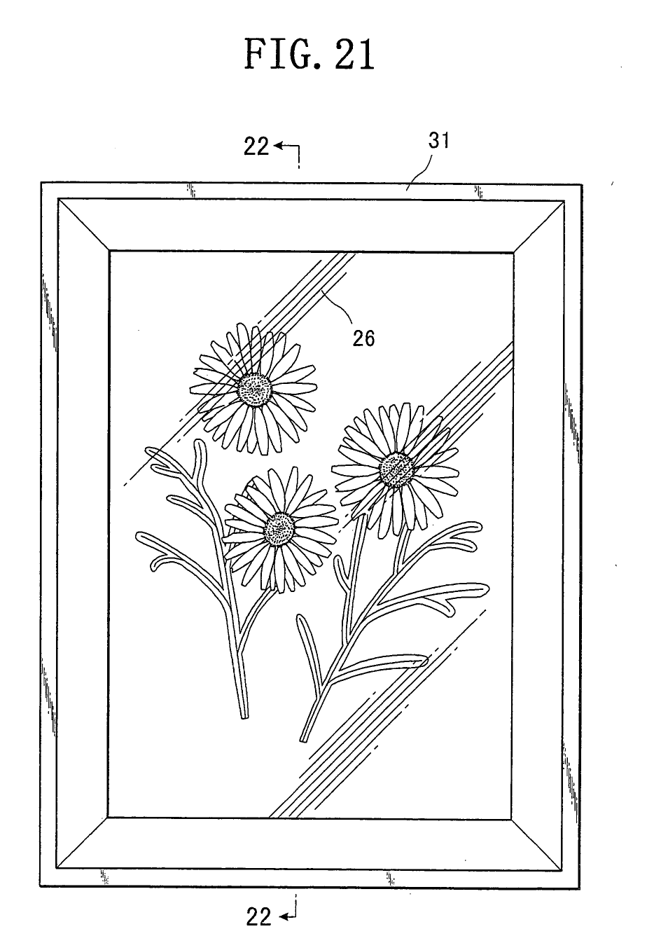

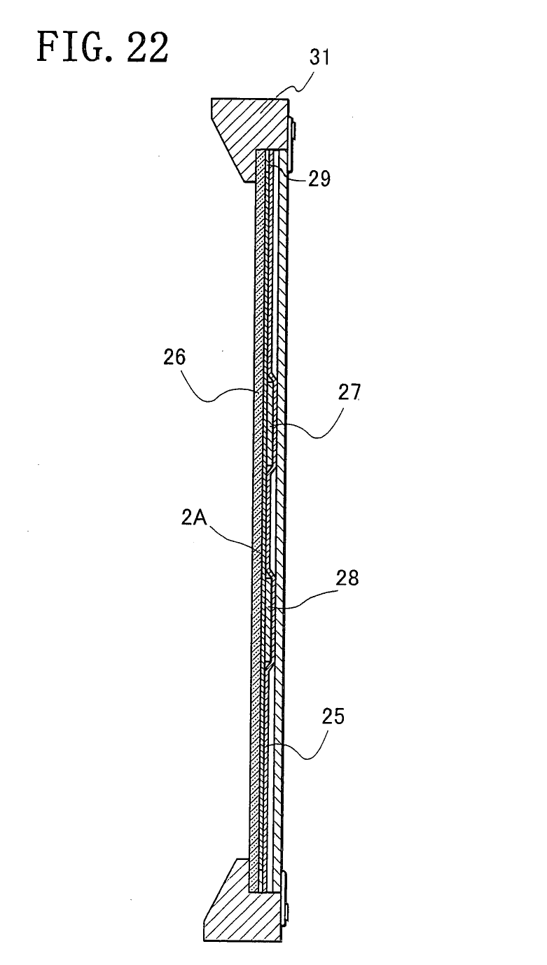

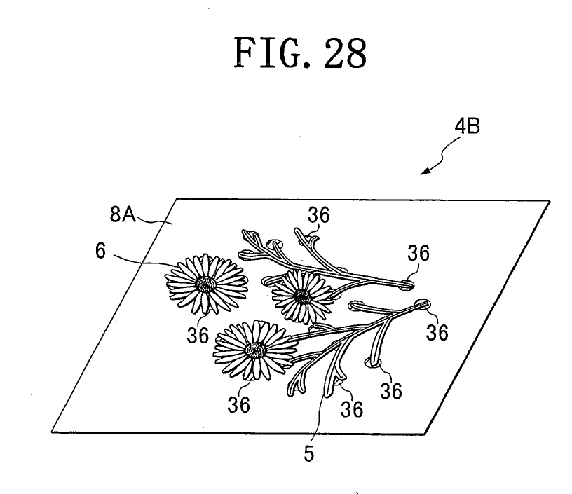

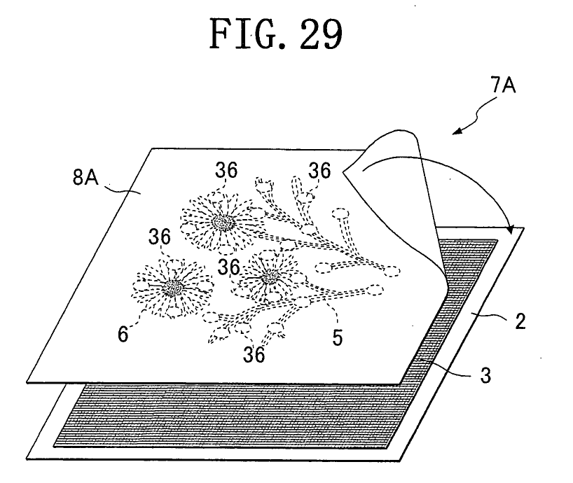

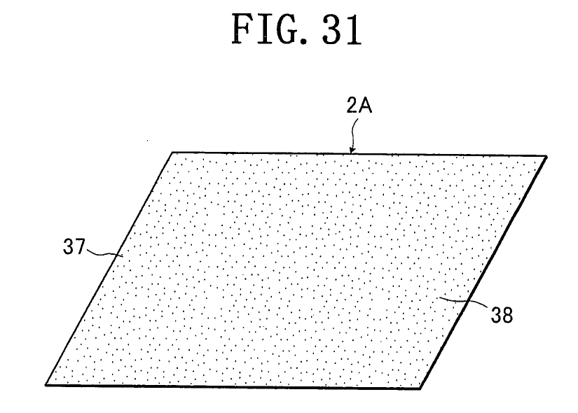

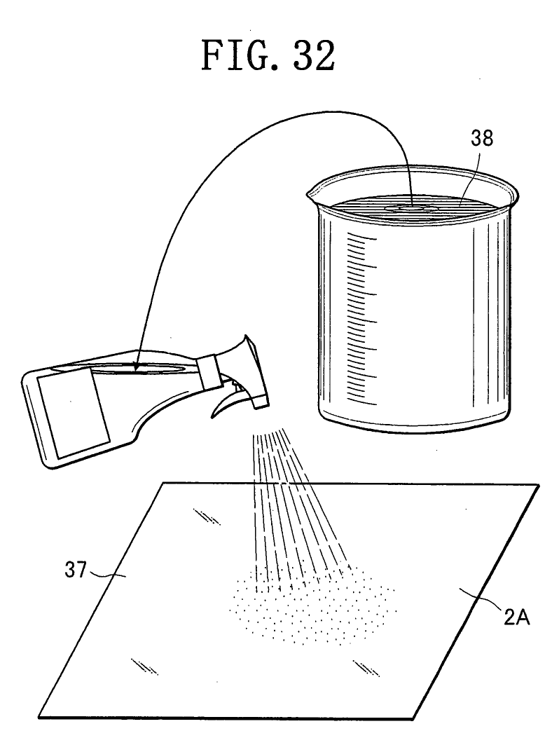

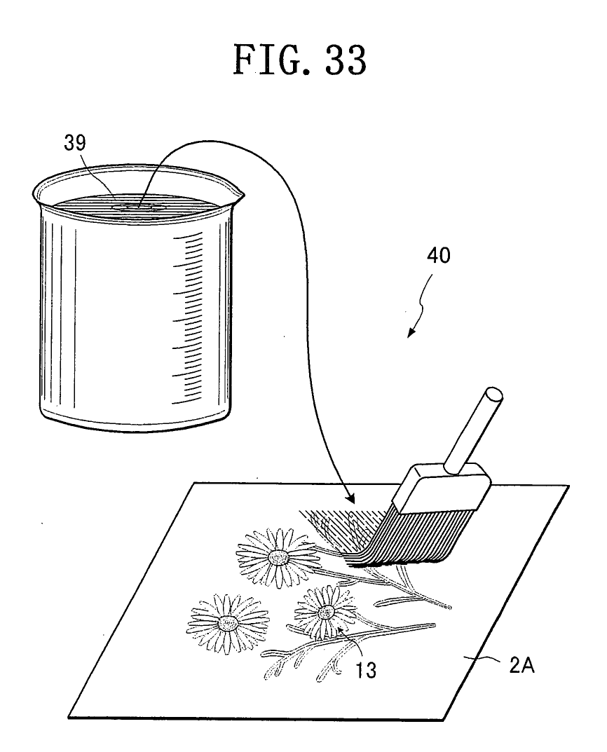

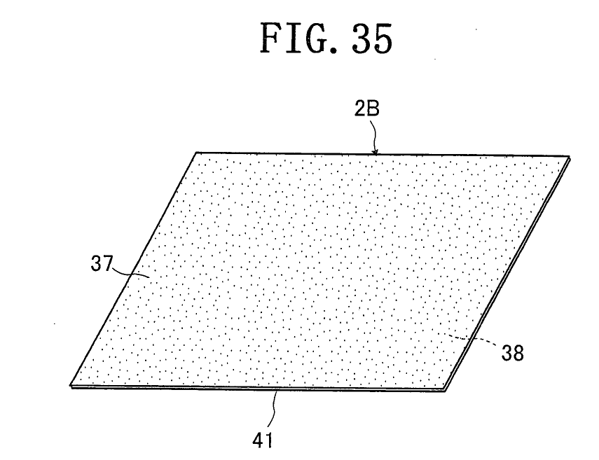

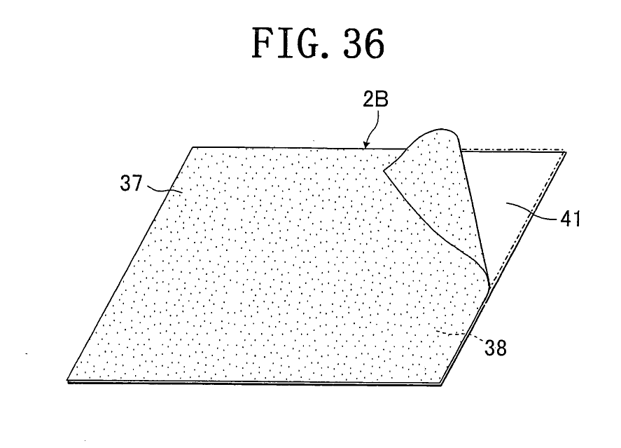

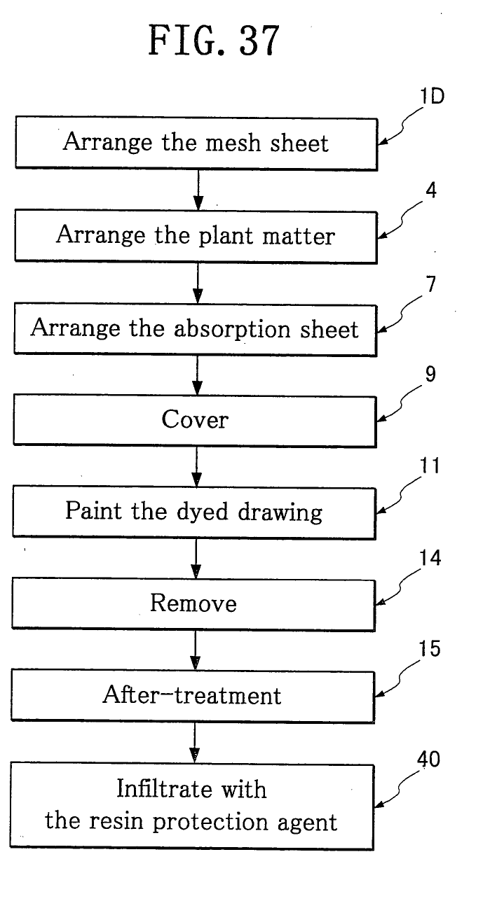

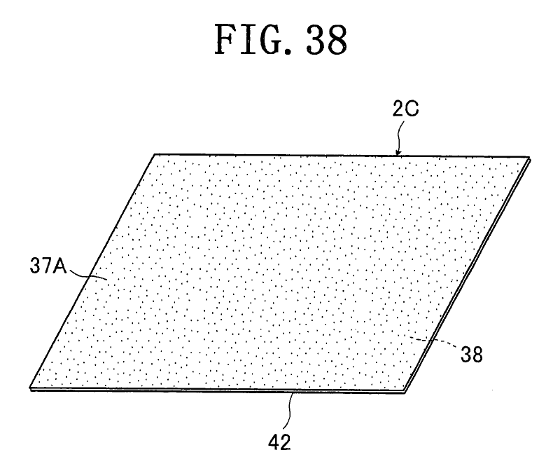

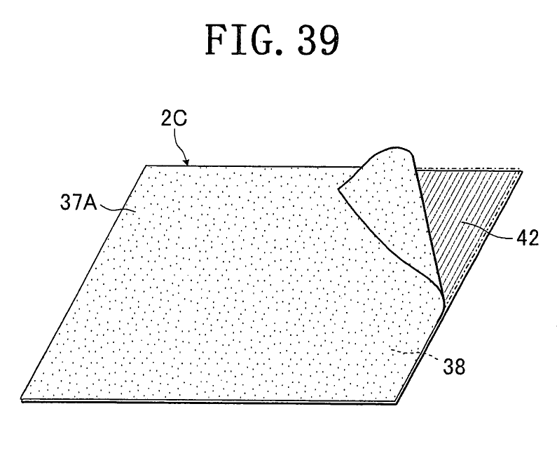

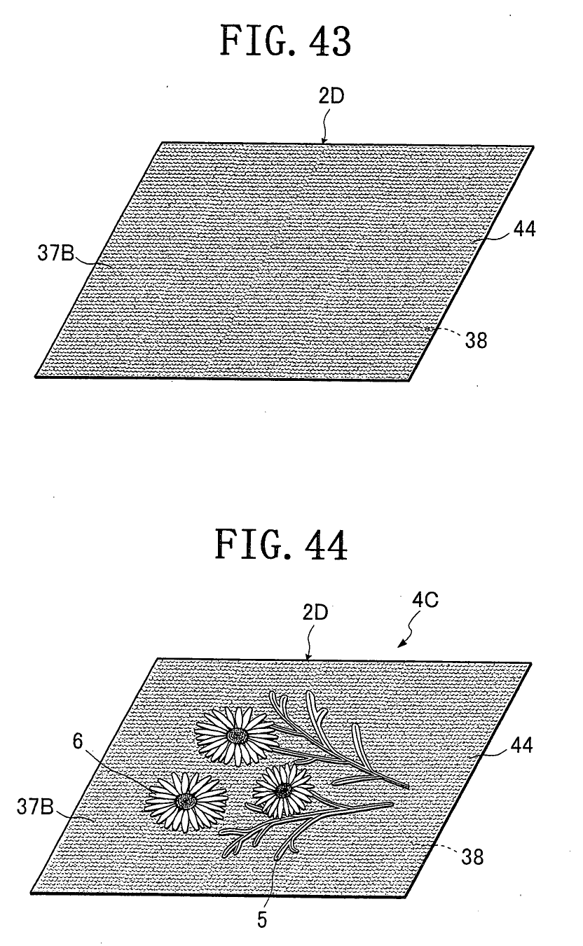

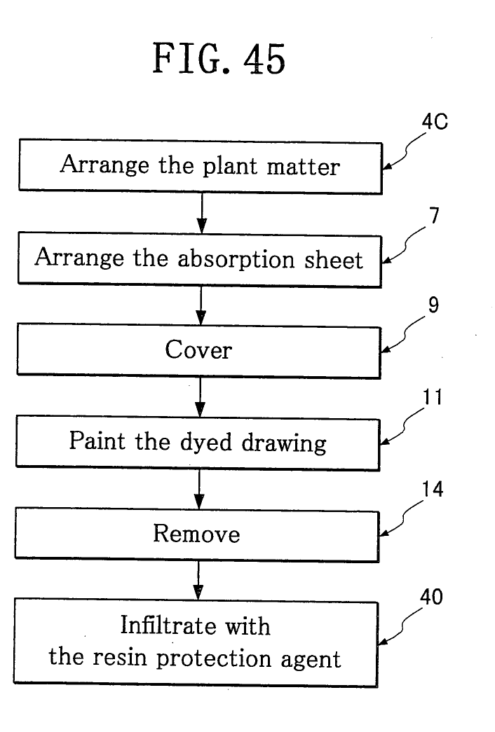

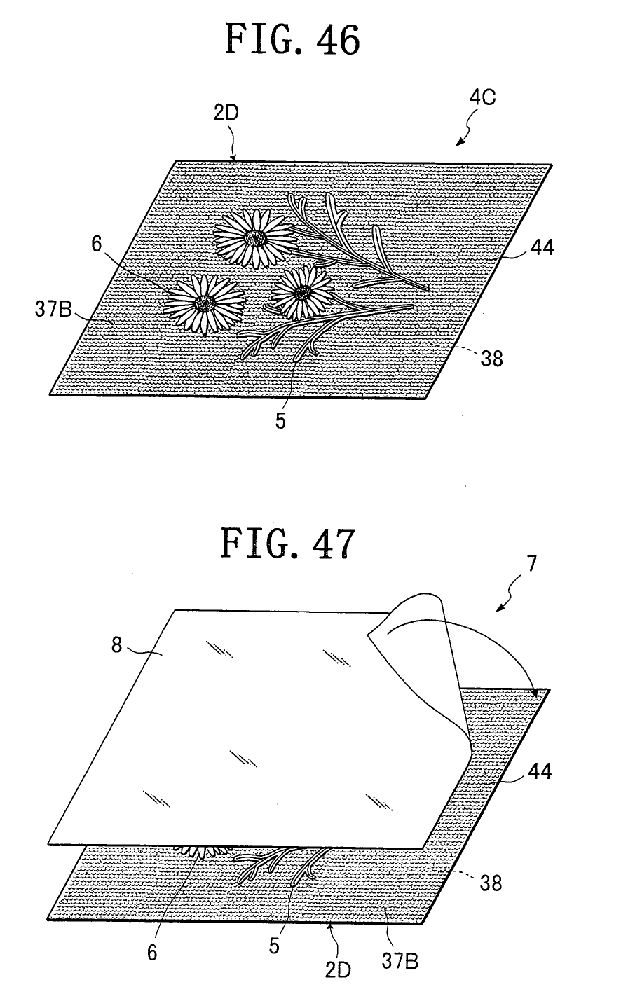

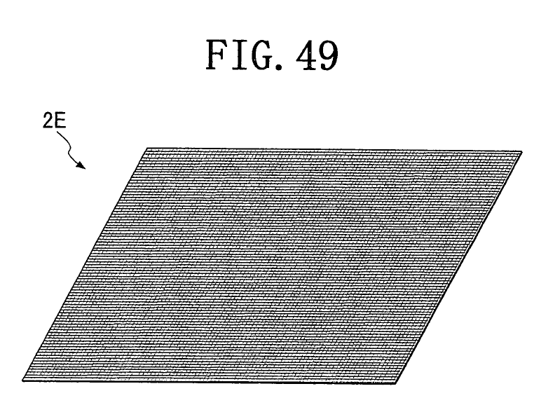

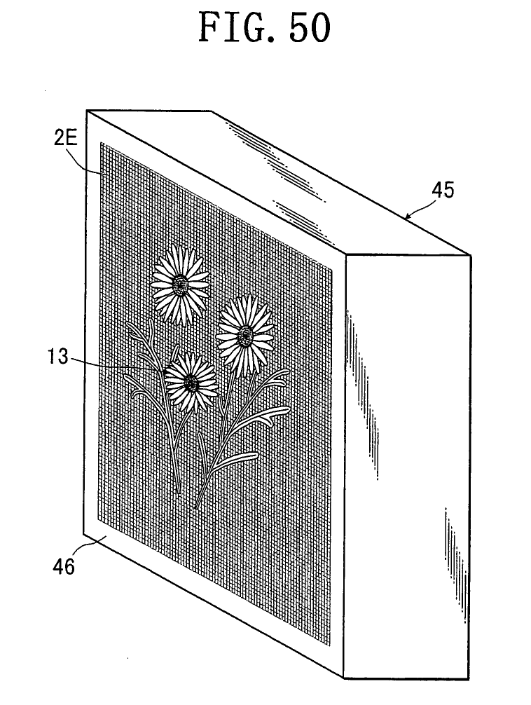

Other embodiments of the present invention will now be described with reference to FIGS. 10-50. In FIGS. 10-50, the same components as in the first embodiment described above with reference to FIGS. 10-50 are designated by the same reference numerals and therefore will not be further explained in great detail.

A second embodiment of the present invention is shown in FIGS. 10-12. It is distinguished from the first embodiment in that the arrangement step is replaced from another step 1A. In this step 1A, a mesh sheet 3A formed of a sand paper formed in the shape of a mesh is used. A creation method of a dyed drawing of a plant matter with the arrangement step 1A can flow out the pigment by scratching efficiently the leaf 5 and flower 6 of the plant matter.

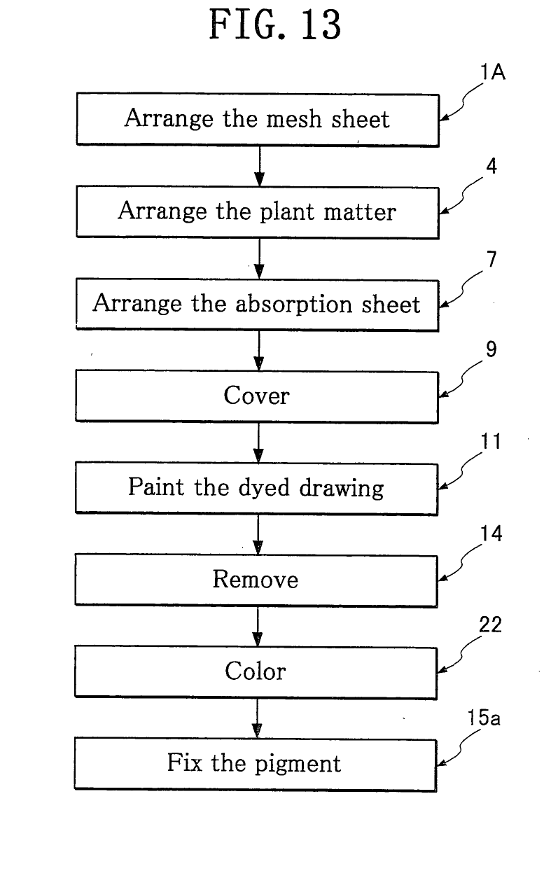

A third embodiment of the present invention is shown in FIGS. 13-15. It is distinguished from the first embodiment in that the after-treatment step 15 is replaced from another after-treatment step 15A which further includes a step 22 for coloring. In the coloring step 22, an acid solution 20 including lactic acid, citric acid for red or purple leaf 5 and flower 6 and an alkali solution 21 including baking soda, sodium hydrate for yellow or green leaf 5 and flower 6 are applied in the dyed drawing 13 of the plant drawn on the canvas 2 for the dyed drawing by a brush 19 before the fixing step 5a is carried out A creation method of a dyed drawing of a plant matter with the after-treatment step 15A including the coloring step 22 according to the second embodiment has similar advantages to that according to the first embodiment and a colorful dyed drawing 13A is created.

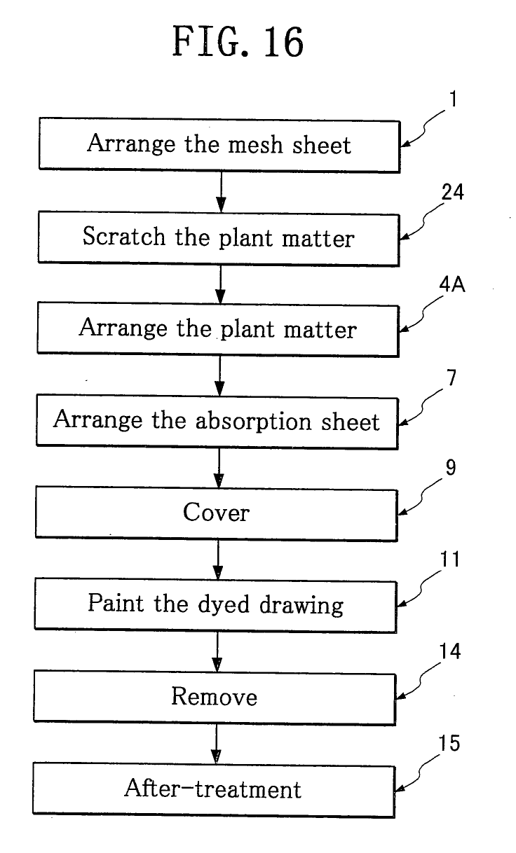

A fourth embodiment of the present invention is shown in FIGS. 16-18. It is distinguished from the first embodiment in that the a step 24 for scratching the surface or back of the leaf 5 and flower 6 with a sand paper so as to flow the pigment out easily after the arrangement step 1 is carried out, after that, a step for arranging the leaf 5 and flower 6 which are scratched on the mesh sheet 3. A creation method of the dyed drawing of a plant matter with the scratching step 24 according to the fourth embodiment has similar advantages to that according to the first embodiment, and the leaf 5 and flower 6 with a low water content can be transfer efficiently the pigment thereof to he canvas 2 for the dyed drawing.

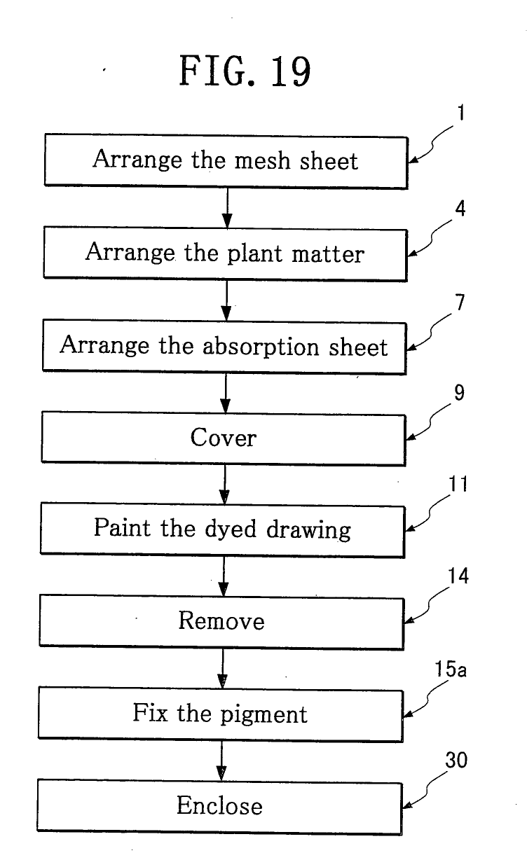

A fifth embodiment of the present invention is shown in FIGS. 19-22. It is distinguished from the first embodiment in that the after-treatment step 15 is replaced from another step 15B which includes a step 30 for enclosing. The enclosing step 30 is carried out after the fixing step 15a is carried out, a canvas 2A for the dyed drawing is interposed between an aluminum foil 25 including the foil adhered a flexible resin sheet at the outer surface thereof and a glass plate 26 through a desiccant 27, a deoxidizer 28 and the like, and the aluminum foil 25 and glass plate 26 are fixed at the outer circumferential part thereof with a adhesive 29 at a sealing state. After that, the canvas 2A is enclosed in a frame 31 and displayed. A creation method of a dyed drawing of a plant matter with the after-treatment step 15B including the enclosing step according to the fifth embodiment may be carried out.

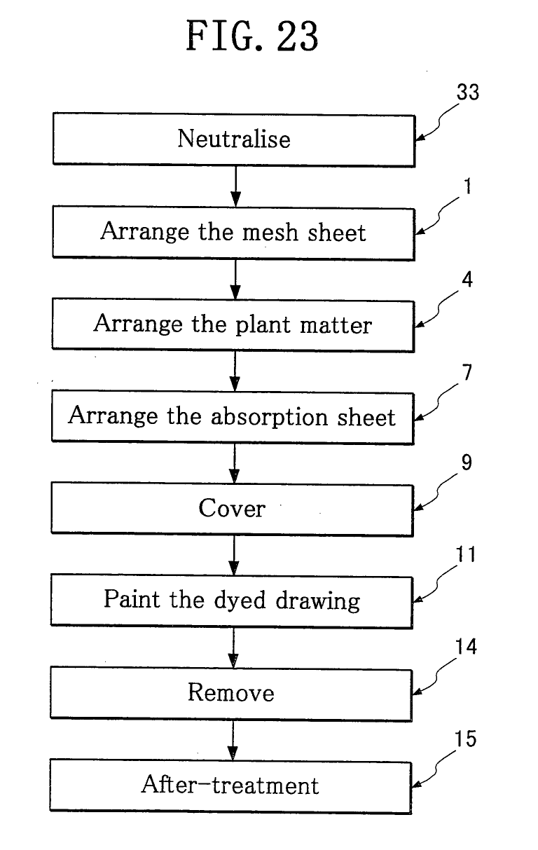

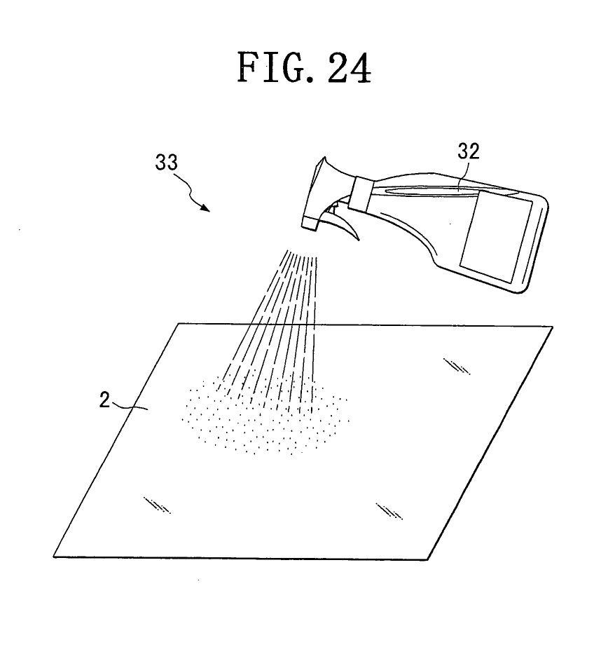

A sixth embodiment of the present invention is shown in FIGS. 23 and 24. It is distinguished from the first embodiment in that a step 33 for neutralizing the canvas 2 before the arrangement step 1 is carried out. In the neutralizing step 33, the alkali solution is applied or sprayed when the acid canvas 2 for the dyed drawing is used, and the acid solution is applied or sprayed when the alkaline canvas 2 for the dyed drawing is used. A creation method of a dyed drawing of a plant matter with the neutralizing step 33 according to the sixth embodiment may be carried out.

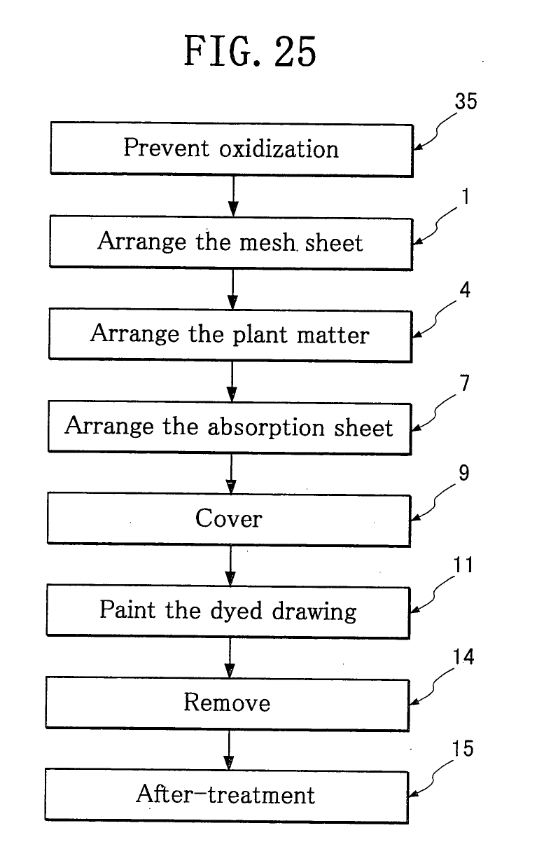

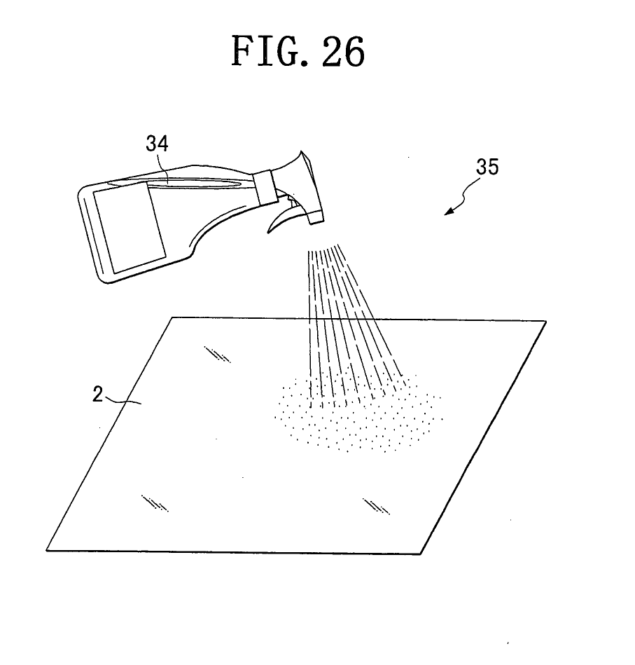

A seventh embodiment of the present invention is shown in FIGS. 25 and 26. It is distinguished from the sixth embodiment in that a step 35 for preventing to oxidize the dyed drawing before the arrangement step 1 is carried out. In the preventing step 35, an anti-oxidization agent 34 is applied or sprayed in the canvas 2 for the dyed drawing. A creation method of a dyed drawing of a plant matter with the preventing step 35 according to the sixth embodiment may be carried out.

In addition, in the embodiments of the prevent invention, the fixing step 15 and coloring step 22 are used as the after-treatment step. Then, only the coloring step 22 may be carried out without the fixing step 15, the after-treatment step without the fixing step 15 and coloring step 22 may be carried out.

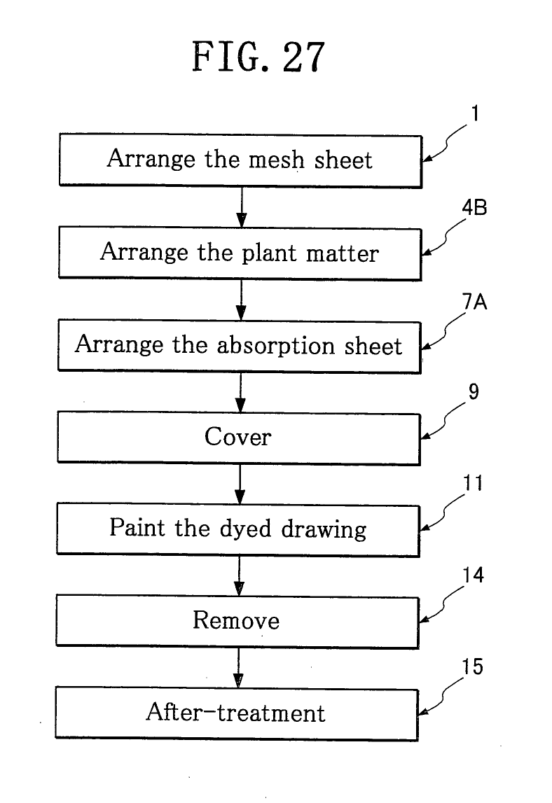

An eighth embodiment of the present invention is shown in FIGS. 27-29. It is distinguished from the first embodiment in that the arrangement step 4 is replaced from another step 4B and the arrangement step 7 is replaced from another 7A. In the arrangement step 4B for the plant matter, the leaf 5 and flower 6 are arranged fixedly on a fixing sheet 8A with non-water absorption rate or with water absorption rate. In the arrangement step 7A, the leaf 5 and flower 6 arranged fixedly on the fixing sheet 8A is located at the upper surface of the mesh sheet 3 after the arrangement step 1 is carried out. A creation method of a dyed drawing of a plant matter with the arrangement step 4B and the arrangement step 7A according to the eighth embodiment has similar advantages to that according to the first embodiment, small leaf 5 and flower 6 do not move, and the work of the dyed drawing can be carried out in the state that they are arranged on the fixing sheet 8A in advance.

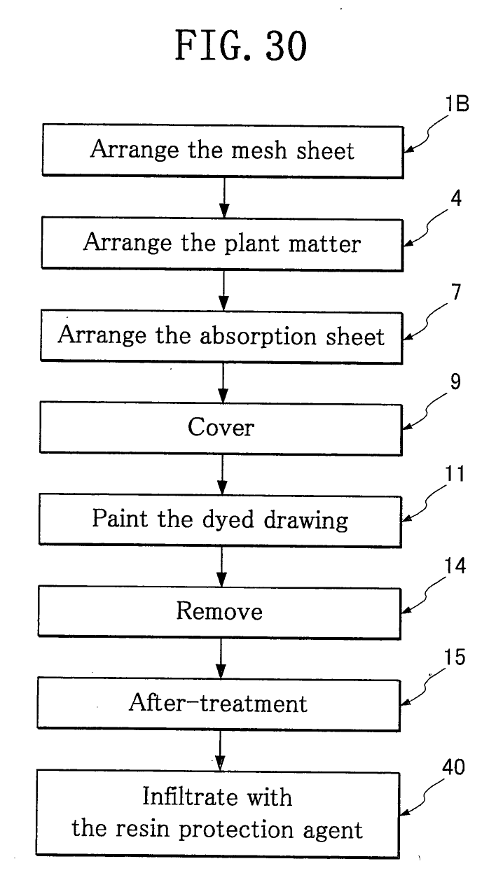

A ninth embodiment of the present invention is shown in FIGS. 30-33. It is distinguished from the first embodiment in that a canvas 2A is comprised of a canvas body 37 which is a drawing paper etc.; and a pH setting solution 38 which is either DL-malic acid, sodium DL-malic acid, phytic acid, citric acid or combined solution with at least two kinds of the above-mentioned liquids, impregnating the canvas 2A so as to set the range of pH of 2.5 to 3.5, capable of keep pH constant over the long term.

The arrangement step 1 is replaced from another step 1B which may be carried out in this embodiment. Also a step 40 for infiltrating with a resin protection agent 39 may be carried out. In the infiltrating step 40 as the after-treatment step, the resin protection agent 39 including polyester resin, acrylic resin, silicon resin, polyethylene resin or the like is infiltrated at least the part of dyed drawing 13 of the canvas 2A.

When a creation method of a dyed drawing of a plant matter with such steps, the pigment can be drawn to the canvas 2A for the dyed drawing at a colorful state since the canvas 2A for the dyed drawing is set at the range of pH of 2.5 to 3.5

In addition, anthocyan and flavone which are pigment of the plant matter is colored well, and it is prevented to change the color or darken according to oxidization and the like.

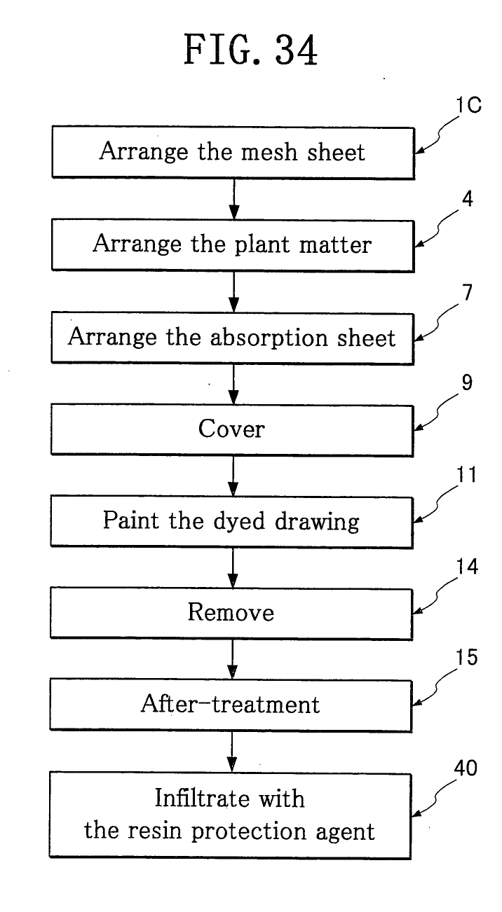

A tenth embodiment of the present invention is shown in FIGS. 34-36. It is distinguished from the ninth embodiment in that the canvas 2A for the dyed drawing is replaced from another canvas 2B including the canvas body 37; and a paper 41 which seldom absorbs water, adhering fixedly to the back surface of the canvas body 37. Then the canvas 2B is used at an arrangement step 1C. A creation method of a dyed drawing of a plant matter with the arrangement step 1C according to the tenth embodiment has similar advantages to that according to the ninth embodiment.

In addition, instead of the paper 41, the synthetic resin sheet, the object formed in the shape of a sheet by applying the resin agent which gets rigid with UV, heat or the like may be adhered to the back of the canvas body 37.

An eleventh embodiment of the present invention is shown in FIGS. 10-12. It is distinguished from the tenth embodiment in that the canvas 2B for the dyed drawing is replaced from another canvas 2C including the canvas body 37; and a paper 42 which seldom absorbs water is adhered to the back of a canvas body 37A for the dyed drawing by using a superabsorbent cloth, board, plaster board, unglazed body or the like, the cloth is used in this embodiment. Then the canvas 2C is used at an arrangement step 1D. A creation method of a dyed drawing of a plant matter with the arrangement step ID according to the eleventh embodiment has similar advantages to that according to the tenth embodiment.

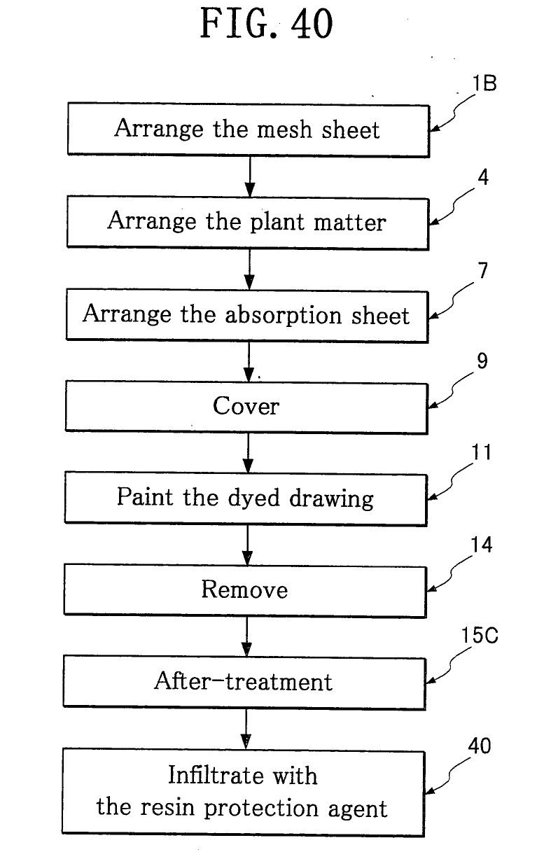

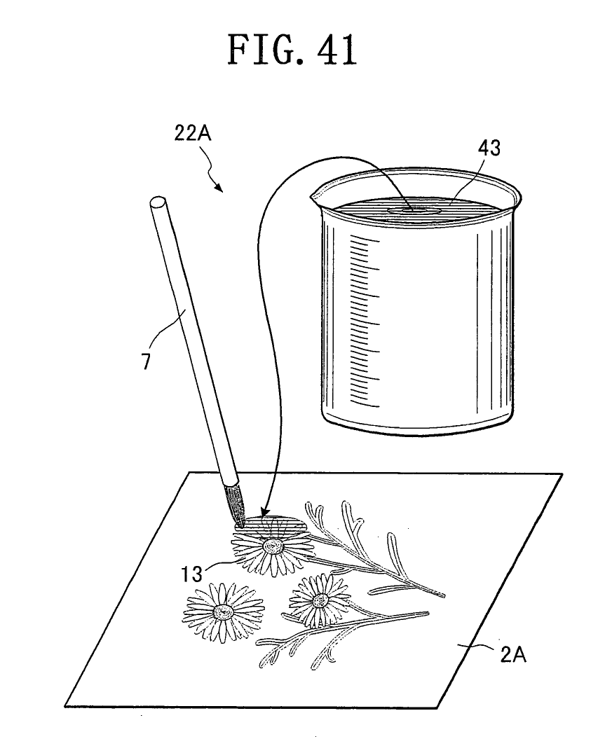

A twelfth embodiment of the present invention is shown in FIGS. 40 and 41. It is distinguished from the ninth embodiment in that a step 22A for coloring. In the coloring step 22A, a solution 43 including baking soda, sodium carbonate and the like with acescence to alkalinity is applied in the part which drawn the dyed drawing 13 by the brush 17 and the like, and the dyed drawing 13 can be colored in a natural color as much as possible. Then the coloring step 22A as the after-treatment step 15C is carried out. A creation method of a dyed drawing of a plant matter with such step according to the twelfth embodiment has similar advantages to that according to the ninth embodiment.

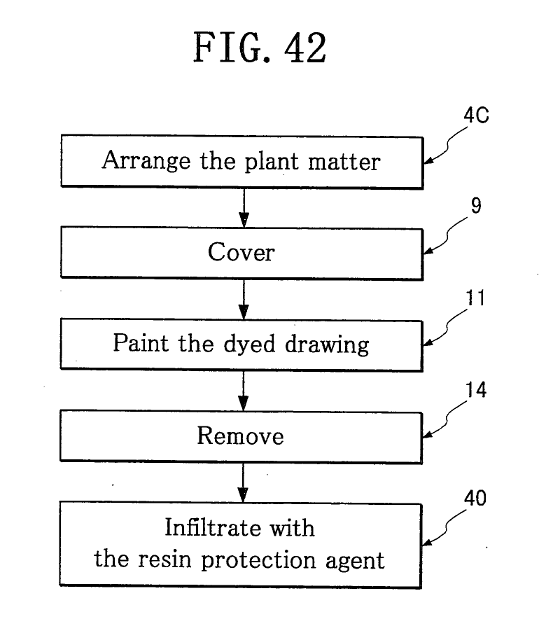

A thirteenth embodiment of the present invention is shown in FIGS. 42-44. It is distinguished from the ninth embodiment in that the canvas 2A is replaced from another 2D including a canvas body 37B which is a superabsorbent paper cloth, board, plaster board, unglazed body or the like which are formed tiny asperities on the surface thereof, the paper is used in this embodiment. Then after a step 4C for arranging which is arranged the leaf 5 and flower 6 on the upper surface of the dyed drawing of the canvas 2D for the dyed drawing is carried out, the covering step 9, drawing step 11, removing step 14 and infiltrating step 40 are carried out in order. A creation method of a dyed drawing of a plant matter with such step according to the thirteenth embodiment has similar advantages to that according to the ninth embodiment.

A fourteenth embodiment of the present invention is shown in FIGS. 10-12. It is distinguished from the thirteenth embodiment in that the step 7 for arranging the absorption sheet 8 which absorbs water of the upper surface of the plant matter is carried out between the arrangement step 4C and covering step 9. A creation method of a dyed drawing of a plant matter with such step according to the fourteenth embodiment has similar advantages to that according to the thirteenth embodiment, and the absorption sheet 8 absorbs water and beautiful dyed drawing is drawn.

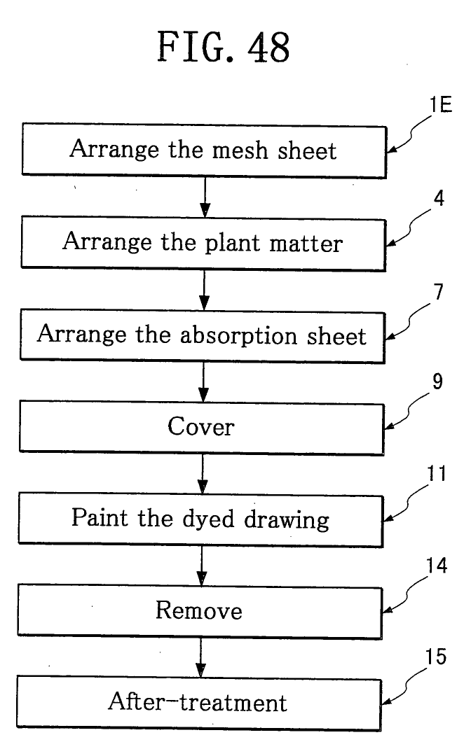

A fifteenth embodiment of the present invention is shown in FIGS. 48-50. It is distinguished from the first embodiment in that the canvas 2 is replaced from another canvas 2E with chemical fiber paper or chemical fiber cloth including rayon, nylon, and acryl etc. that it is easy to be stained by a dye and which doesn't contain water-soluble element so as to affect pH of the plant matter. Then an arrangement step 1E is carried out. A creation method of a dyed drawing of a plant matter with such step according to the fifteenth embodiment has similar advantages to that according to the first embodiment, and the canvas 2E drawn he dyed drawing 13 is adhered to the surface of a decoration body 45 which is formed in the shape of a flat surface or cubic with a transparent resin 46, including a transparent silicon resin, which does not affect pH of the plant matter so that the canvas 2E is in a transparence as much as possible as the object looks clean when it immerses in water, and it is honed to beautiful.

In addition, the silicon resin for adhering may be applied in the surface of the canvas 2E for the dyed drawing.

In the embodiment, the canvas 2E may be used as the canvas treated for anti-oxidization, canvas treated for acid, canvas treated for a fixing agent, canvas attached the board at back thereof, canvas processed which are formed tiny asperities on the surface without the mesh sheet or canvas, which is cloth, paper or the like, which does not affect pH of the plant matter.

Moreover, in each of the embodiments in the present invention, when the back of the leaf 5 and the surface of the flower 6 of the plant matter which are arranged at the upper surface of the mesh sheet or canvas for the dyed drawing are arranged, almost of the plant matters can flow the pigment out efficiently.

Furthermore, in the embodiments of the present invention, the step 7 for arranging the thin absorption sheet 8 with water absorption rate including tissue paper, toilet paper, etc., which covers the upper surface of the plant matter after the arrangement step 4 is carried out and the step for covering the transparent or translucent synthetic resin sheet 10 on the upper surface of the water absorption sheet 8 after the arrangement step 7 is carried out are explained. Also the steps without the step 7 for arranging the absorption sheet may be carried out, and the step 9 for covering using the synthetic resin sheet other than the transparent or translucent synthetic resin sheet 10 may be carried out.

As set forth above, the advantages of the invention are as follows:

(1) A creation method of a dyed drawing of a plant matter includes a step of arranging a mesh sheet at a surface part of a canvas for a dyed drawing which is drawn the dyed drawing; arranging leaves and flowers of the plant matter on an upper surface of the mesh sheet after the mesh sheet arrangement step is carried out; covering the plant matter with one of a transparent and a translucent synthetic resin sheet after the arrangement step for the plant matter is carried out; painting the dyed drawing at a canvas for the dyed drawing, including pushing the leaf and flower of the plant matter to the mesh sheet after pressing the synthetic resin sheet by one of a spatula and a roller, flowing a pigment of the leaf and flower out, and adhering the pigment to the canvas after the covering step is carried out; and removing the mesh sheet, the leaf and flower of the plant matter and the synthetic resin sheet which are located on the surface of the canvas for the dyed drawing after the painting step is carried out. Therefore, the pigment can be flown out after the leaf and flower are pressed to the mesh sheet by the spatula and scratched.

Therefore, the pigment can be flown out efficiently, and the pigment can be adhered to the object for the dyed drawing.

(2) As discussed above, the absorption sheet and synthetic resin sheet cover the upper part of the leaf and flower and are pressed by the spatula Therefore, the movement of the leaf and flower can be prevented efficiently by carrying out so as to move the synthetic resin sheet during the pressing of the spatula, and the pigment of the shape of the leaf and flower can be adhered to the object for the dyed drawing at a transferring state.

(3) As discussed above, even though the leaf and flower of the plant matter is separated by pressing the spatula, the leaf and flower can be removed with the mesh sheet at the attached state when the mesh sheet is taken away.

Therefore, it is prevented to adhere the leaf and flower to the object of the dyed drawing, the beautiful dyed drawing can be created.

(4) Also claims 2 to 10 are achieved with the same effect as the above (1) to (3).

(5) In claim 10, when the absorption sheet is used, it absorbs the extra pigment which flows out of the leaf and flower of the plant matter and it can be prevented to fade in color of the dyed drawing. In addition, the absorption sheet absorbs water so that the outline of the leaf and flower is clear, the pressure power of the spatula can be controlled, and the beautiful dyed drawing can be created.

(6) Also claim 11 is achieved with the same effect as the above (1) to (3), and the dyed drawing that is drawn in the canvas is cleaned up and can be prevented to change color in the after-treatment step.

(7) Also claims 12, 13, 14 and 15 are achieved with the same effect as the above (6).

(8) Also claims 16, 17, 18 and 19 are achieved with the same effect as the above (1) to (3).

1. A creation method of a dyed drawing of a plant matter comprising a step of:
arranging a mesh sheet at a surface part of a canvas for a dyed drawing which is drawn the dyed drawing;
arranging leaves and flowers of the plant matter on an upper surface of the mesh sheet after the mesh sheet arrangement step is carried out;
covering the plant matter with one of a transparent and a translucent synthetic resin sheet after the arrangement step for the plant matter is carried out;
painting the dyed drawing at a canvas for the dyed drawing, including pushing the leaf and flower of the plant matter to the mesh sheet after pressing the synthetic resin sheet by one of a spatula and a roller, flowing a pigment of the leaf and flower out, and adhering the pigment to the canvas after the covering step is carried out; and
removing the mesh sheet, the leaf and flower of the plant matter and the synthetic resin sheet which are located on the surface of the canvas for the dyed drawing after the painting step is carried out.

2. A creation method of a dyed drawing of a plant matter according to claim 1 wherein the canvas further includes a canvas body which is made of one of a drawing paper, cloth, cotton cloth and canvas; and an absorption agent of a pigment which is made of one of an alcohol, water, acid liquid and these mixtures which is one of impregnated, applied and sprayed so as to be absorbed the pigment of the plant matter to one of a part and whole surface of the canvas body of the dyed drawing.

3. A creation method of a dyed drawing of a plant matter according to claim 1 wherein the canvas further includes a canvas body which is made of one of a drawing paper, cloth, cotton cloth and canvas; and an anti-discoloration agent of the pigment which is made of one of a pH setting solution and an anti-oxidization agent which is one of impregnated, applied and sprayed so as to prevent to change the color of the pigment of the plant matter to one of a part and whole surface of the canvas body of the dyed drawing.

4. A creation method of a dyed drawing of a plant matter according to claim 1 wherein the canvas further includes a canvas body which is made of one of a superabsorbent cloth, board, plaster board and unglazed body with tiny asperities on a surface thereof; and a pH setting solution which is one of a DL-malic acid, sodium DL-malic acid, phytic acid, citric acid and combined solution with at least two kinds of the above-mentioned solutions, impregnating the canvas so as to set the range of pH of 2.5 to 3.5.

5. A creation method of a dyed drawing of a plant matter according to claim 1 wherein the canvas further includes a canvas body which is made of one of a superabsorbent cloth, board, plaster board and unglazed body with tiny asperities on a surface thereof; a filtration protection sheet which is one of a paper which seldom absorbs water and a synthetic resin sheet, providing to a back surface of the canvas body; and a pH setting solution which is one of a DL-malic acid, sodium DL-malic acid, phytic acid, citric acid and combined solution with at least two kinds of the above-mentioned solutions, impregnating the canvas so as to set the range of pH of 2.5 to 3.5.

6. A creation method of a dyed drawing of a plant matter according to claim 1 wherein the canvas is formed one of a chemical fiber paper and chemical fiber cloth which is made of one of a rayon, nylon and acryl which doesn't contain water-soluble element which affects to pH of the plant matter.

7. A creation method of a dyed drawing of a plant matter according to claim 1 wherein the canvas includes a canvas body which is one of a chemical fiber paper and chemical fiber cloth which is made of one of a rayon, nylon and acryl which doesn't contain water-soluble element which affects to pH of the plant matter; and a board attached fixedly to a back of the canvas body.

8. A creation method of a dyed drawing of a plant matter according to claim 1 wherein the mesh sheet in the arrangement step for the mesh sheet is formed of meshes having approximately 0.1 millimeters to several millimeters, the meshes which is made of threads of the kind of synthetic resin material.

9. A creation method of a dyed drawing of a plant matter according to any claim 1 to 8 wherein the leaf and flower arranged on the mesh sheet in the arrangement step for the plant matter is used one of as it is and the leaf and flower with hurts, scratching an attaching surface to the mesh sheet with a surface of a sand paper.

10. A creation method of a dyed drawing of a plant matter according to any claim 1 to 8 wherein the step for covering one of a transparent or translucent synthetic resin sheet on the upper surface of the leaf and flower arranged on the mesh sheet and the transparent or translucent synthetic resin sheet after the thin water absorption sheet with water absorption rate covers the upper surface of the plant matter.

11. A creation method of a dyed drawing of a plant matter comprising a step of:
arranging a mesh sheet at a surface part of a canvas for a dyed drawing which is drawn the dyed drawing;
arranging leaves and flowers of the plant matter on an upper surface of the mesh sheet after the mesh sheet arrangement step is carried out;
covering the plant matter with one of a transparent and a translucent synthetic resin sheet after the arrangement step for the plant matter is carried out;
painting the dyed drawing at a canvas for the dyed drawing, including pushing the leaf and flower of the plant matter to the mesh sheet after pressing the synthetic resin sheet by one of a spatula and a roller, flowing a pigment of the leaf and flower out, and adhering the pigment to the canvas after the covering step is carried out;
removing the mesh sheet, the leaf and flower of the plant matter and the synthetic resin sheet which are located on the surface of the canvas for the dyed drawing after the painting step is carried out; and
after-treating one of cleaning up the dyed drawing that is drawn in the canvas and preventing to change color.

12. A creation method of a dyed drawing of a plant matter according to claim 11 wherein the step for after-treatment is a step for coloring by applying one of an acid solution and an alkali solution in the dyed drawing drawn on the canvas for the dyed drawing by a brush.

13. A creation method of a dyed drawing of a plant matter according to claim 11 wherein the step for after-treatment is a step for fixing the pigment of the dyed drawing by applying a fixing solution.

14. A creation method of a dyed drawing of a plant matter according to claim 11 wherein the step for after-treatment further including:
coloring by applying one of an acid solution and an alkali solution in the dyed drawing drawn on the canvas for the dyed drawing by a brush; and
fixing the pigment of the dyed drawing by applying a fixing solution.

15. A creation method of a dyed drawing of a plant matter according to any claim 11 to 14 wherein the step for after-treatment is a step for infiltrating with a resin protection agent including polyester resin, acrylic resin, silicon resin and polyethylene resin to the surface of the dyed drawing of the canvas.

16. A creation method of a dyed drawing of a plant matter comprising a step of:
arranging leaves and flowers of the plant matter on an upper surface of a canvas for a dyed drawing;
covering the plant matter with one of a transparent and a translucent synthetic resin sheet after the arrangement step for the plant matter is carried out;
painting the dyed drawing at the canvas for the dyed drawing, including pushing the leaf and flower of the plant matter to the mesh sheet after pressing the synthetic resin sheet by one of a spatula and a roller, flowing a pigment of the leaf and flower out, and adhering the pigment to the canvas after the covering step is carried out; and
removing the leaf and flower of the plant matter and the synthetic resin sheet which are located on the surface of the canvas for the dyed drawing after the painting step is carried out.

17. A creation method of a dyed drawing of a plant matter comprising a step of:
arranging leaves and flowers of the plant matter on an upper surface of a canvas for a dyed drawing;
covering the plant matter with one of a transparent and a translucent synthetic resin sheet after the arrangement step for the plant matter is carried out;
painting the dyed drawing at the canvas for the dyed drawing, including pressing the synthetic resin sheet by one of a spatula and a roller, flowing a pigment of the leaf and flower out, and adhering the pigment to the canvas after the covering step is carried out;
removing the leaf and flower of the plant matter and the synthetic resin sheet which are located on the surface of the canvas for the dyed drawing after the painting step is carried out; and
after-treating one of cleaning up the dyed drawing that is drawn in the canvas and preventing to change color.

18. A creation method of a dyed drawing of a plant matter comprising a step of:
arranging a mesh sheet at a surface part of a canvas for a dyed drawing which is drawn a dyed drawing;
arranging fixedly leaves and flowers of the plant matter on an upper surface of a fixing sheet which is overlapped at the mesh sheet after the mesh sheet arrangement step is carried out;
arranging the fixing sheet with the leaf and flower on the mesh sheet;
covering a synthetic resin sheet on the upper surface of the fixing sheet after the arrangement step for the fixing sheet is carried out;
painting the dyed drawing at a canvas for the dyed drawing, including pressing the synthetic resin sheet by one of a spatula and a roller, flowing a pigment of the leaf and flower which are arranged fixedly at the fixing sheet out, and adhering the pigment to the canvas after the covering step is carried out; and
removing objects including the mesh sheet, the leaf and flower of the plant matter and the synthetic resin sheet which are located on the surface of the canvas for the dyed drawing after the painting step is carried out.

19. A creation method of a dyed drawing of a plant matter comprising a step of:
arranging a mesh sheet at a surface part of a canvas for a dyed drawing which is drawn a dyed drawing;
arranging fixedly leaves and flowers of the plant matter on an upper surface of a fixing sheet which is overlapped at the mesh sheet after the mesh sheet arrangement step is carried out;
arranging the fixing sheet with the leaf and flower on the mesh sheet;
covering a synthetic resin sheet on the upper surface of the fixing sheet after the arrangement step for the fixing sheet is carried out;
painting the dyed drawing at a canvas for the dyed drawing, including pressing the synthetic resin sheet by one of a spatula and a roller, flowing a pigment of the leaf and flower which are arranged fixedly at the fixing sheet out, and adhering the pigment to the canvas after the covering step is carried out;
removing objects including the mesh sheet, the leaf and flower of the plant matter and the synthetic resin sheet which are located on the surface of the canvas for the dyed drawing after the painting step is carried out; and
after-treating one of cleaning up the dyed drawing that is drawn in the canvas and preventing to change color.
